(19) United States
(12) Patent Application Publication
(10) Pub. No.: US 2026/0170390 A1
(43) Pub. Date: Jun. 18, 2026

(54) Sparsity Preserving Differentially Private Training

(71) Applicant: Google LLC, Mountain View, CA (US)

(72) Inventors: Badih Ghazi, Cupertino, CA (US); Yangsibo Huang, Princeton, NJ (US); Pritish Kamath, Mountain View, CA (US); Shanmugasundaram Ravikumar, Piedmont, CA (US); Pasin Manurangsi, Bankkok (TH); Ames Sinha, San Francisco, CA (US); Chiyuan Zhang, Mountain View, CA (US)

(21) Appl. No.: 18/718,113

(22) PCT Filed: Dec. 7, 2023
(86) PCT No.: PCT/US2023/082829

§ 371 Date: Jun. 10, 2024

Related U.S. Application Data
(60) Provisional application No. 63/530,084, filed on Aug. 1, 2023.

(51) Int. Cl. G06N 20/00; G06N 3/084

(52) U.S. Cl. CPC G06N 20/00; G06N 3/084

(57) ABSTRACT

Aspects of the disclosure are directed to methods, system, and/or non-transitory computer readable media for implementing differentially private filtering enabled sparse training and/or adaptive filtering enabled sparse training. The differentially private filtering can enable sparse training and/or adaptive filtering enabled sparse training can preserve gradient sparsity during training of large embedding models. The training can protect data privacy and achieve substantial reductions, e.g., 10⁶ times, in gradient size while maintaining comparable levels of accuracy to differentially private stochastic gradient descent training.

### CROSS-REFERENCE TO RELATED APPLICATIONS

The present application claims the benefit of the filing date of U.S. Provisional Patent Application No. 63/530,084, filed Aug. 1, 2023, the disclosure of which is hereby incorporated herein by reference.

### BACKGROUND

Large embedding models have emerged as a fundamental tool for various applications in recommendation systems and natural language processing, such as digital content management like online advertising. For example, in the online advertising domain, the primary objective may be to predict whether a user will perform a useful action on an advertiser website, e.g., purchase an advertised product, after interacting with an advertisement on a publisher website, e.g., clicking the advertisement. Large embedding models map categorical or string-valued input attributes with large vocabularies to fixed-length vector representations using embedding layers, which enable integrating non-numerical data into deep learning models. These models are widely deployed in personalized recommendation systems and can achieve state-of-the-art performance in language tasks such as language modeling, sentiment analysis, and question-answering.

However, the use of large embedding models may raise concerns about privacy, as it can involve the processing of user information. To enable private data analysis, differential privacy is a widely adopted notion that may guarantee privacy of individual user information while still allowing for analysis of population-level patterns. For training deep neural networks with differential privacy guarantees, the most widely used methodology is differentially private stochastic gradient descent (DP-SGD), which clips per-example gradient contributions and adds noise to the average gradient updates during each iteration of the stochastic gradient descent. DP-SGD has demonstrated its effectiveness in protecting user privacy while maintaining model utility in a variety of applications, such as digital content management.

Nonetheless, implementing DP-SGD in training large embedding models presents unique technical challenges. The large embedding models typically contain non-numerical feature fields like product identifiers and categories, as well as words or tokens that are transformed into dense vectors through an embedding layer. Due to the large vocabulary sizes of these features, training can require embedding tables with a substantial number of parameters. In contrast to the number of parameters, the gradient updates are usually sparse because each mini-batch of examples activates a fraction of the embedding rows. This sparsity can be leveraged for industrial applications that efficiently handle the training of large-scale embeddings. However, DP-SGD removes the gradient sparsity as it requires aggregating and adding independent Gaussian noise to coordinates, resulting in private training of large embedding models with significantly reduced training efficiency compared to non-private training.

### BRIEF SUMMARY

Aspects of the disclosure are directed to methods, system, and/or non-transitory computer readable media for implementing differentially private filtering enabled sparse training and/or adaptive filtering enabled sparse training. The differentially private filtering can enable sparse training and/or adaptive filtering enabled sparse training can preserve gradient sparsity during training of large embedding models. The training can protect data privacy and achieve substantial reductions, e.g., 10⁶ times, in gradient size while maintaining accuracy.

An aspect of the disclosure provides for a method for training a sparse machine learning model including: receiving, by one or more processors, a training dataset and a plurality of model parameters; computing, by the one or more processors, a plurality of per-example gradient contributions from the training dataset and the plurality of model parameters based on one or more training parameters; aggregating and adding, by the one or more processors, noise to the plurality of per-example gradient contributions based on a privacy parameter to generate a noisy batch-wise gradient contribution; filtering, by the one or more processors, the noisy batch-wise gradient contribution based on a frequency parameter to generate a filtered batch-wise gradient contribution; and updating, by the one or more processors, the plurality of model parameters to generate a plurality of updated model parameters based on the filtered batch-wise gradient contribution. Another aspect of the disclosure provides for a system including: one or more processors; and one or more storage devices coupled to the one or more processors and storing instructions that, when executed by the one or more processors, cause the one or more processors to perform the method for training a sparse machine learning model. Yet another aspect of the disclosure provides for a non-transitory computer readable medium for storing instructions that, when executed by one or more processors, cause the one or more processors to perform the method for training a sparse machine learning model.

In an example, the one or more training parameters include at least one of learning rate, number of training steps, batch size, noise multiplier, or clipping norm. In another example, the method further includes clipping, by the one or more processors, the plurality of per-example gradient contributions.

In yet another example, the method further includes iteratively performing the computing, aggregating, adding, denoising, and updating for a number of training steps. In yet another example, the method further includes outputting, by the one or more processors, a trained machine learning model with trained model parameters after performing the number of training steps.

In yet another example, each of the plurality of per-example gradient contributions includes a per-example gradient and a gradient contribution map. In yet another example, the noisy batch-wise gradient contribution includes a private contribution map.

In yet another example, filtering the noisy batch-wise gradient contribution further includes removing per-example gradients that are below a threshold associated with the frequency parameter. In yet another example, the method further includes aggregating and adding, by the one or more processors, noise to the filtered batch-wise gradient contribution based on the first privacy parameter or a second privacy parameter.

In yet another example, the sparse machine learning model includes an embedding model.

### BRIEF DESCRIPTION OF THE DRAWINGS

FIG. 1 depicts a block diagram of an example adaptive filter according to aspects of the disclosure.

FIG. 2 depicts a block diagram of an adaptive filtering differentially private training system for training machine learning models with differentially private labels according to aspects of the disclosure.

FIG. 3 depicts a block diagram of an example environment for implementing an adaptive filtering training system according to aspects of the disclosure.

FIG. 4 depicts a block diagram illustrating one or more machine learning model architectures according to aspects of the disclosure.

FIG. 5 depicts a flow diagram of an example process for a training step for training one or more sparse machine learning models while guaranteeing differential privacy according to aspects of the disclosure.

FIG. 6 depicts a flow diagram of an example process for training one or more sparse machine learning models while guaranteeing differential privacy according to aspects of the disclosure.

FIG. 7 depicts example graphs comparing best gradient size reduction at different thresholds for utility difference where a higher curve indicates a better utility-efficiency trade-offs according to aspects of the disclosure.

FIG. 8 depicts example graphs comparing best gradient size reduction at different privacy parameters according to aspects of the disclosure.

FIG. 9 depicts example graphs comparing best gradient size reduction for time series data with different streaming periods according to aspects of the disclosure.

FIG. 10 depicts an example graph showing best gradient size reduction for time series data of a combined approach according to aspects of the disclosure.

FIG. 11 depicts an example table illustrating best gradient size reduction for language models according to aspects of the disclosure.

### DETAILED DESCRIPTION

As the use of embedding models in recommendation systems and language applications increases, concerns over data privacy have also risen. Differentially private stochastic gradient descent can be utilized to train models while protecting data privacy. However, implementing differentially private stochastic gradient descent naively to embedding models can destroy gradient sparsity, resulting in reduced training efficiency.

The technology generally relates to sparsity preserving differentially private training, such as for a sparsity preserving differential privacy system that can train machine learning models in a sparsity-preserving manner. The sparsity preserving differential privacy system can implement differentially private filtering enabled sparse training and/or adaptive filtering enabled sparse training, allowing for preserving gradient sparsity during training of large embedding models. The training can protect data privacy and achieve substantial reductions, e.g., 10⁶ times, in gradient size while maintaining accuracy.

Sparsity preserving differentially private training, such as for training sparse machine learning models like embedding models, includes: selecting, by one or more processors, one or more buckets of categorical features for training the sparse machine learning model based on a frequency of the one or more buckets in a dataset; and adding, by the one or more processors, noise to respective gradients of the one or more buckets.

In an example, selecting the one or more buckets includes selecting one or more top-k most frequent buckets of each categorical feature. In another example, selecting the one or more buckets is based on historical information on bucket frequency. In yet another example, selecting the one or more buckets is based on differentially private top-k selection. In yet another example, the noise includes Gaussian noise.

In yet another example, selecting the one or more buckets further includes: for each of one or more batches of the dataset, computing a per-example gradient contribution and a gradient contribution map; aggregating the per-example gradient contributions across the one or more batches based on the gradient contribution map to generate a batch-wise gradient contribution; adding noise to the batch-wise gradient contribution to generate a noisy batch-wise gradient contribution; and thresholding the noisy batch-wise gradient contribution based on a frequency parameter to exclude non-significant gradient entries.

In yet another example, the noise added to the batch-wise gradient contribution includes Gaussian noise. In yet another example, the gradient contribution map includes a binary vector indicating which categorical feature buckets are activated for each example in the batch. In yet another example, aggregating the per-example gradient contributions further includes implementing per-example gradient clipping. In yet another example, the frequency parameter is configurable. In yet another example, thresholding the noisy batch-wise gradient contribution further includes keeping buckets of categorical features that have a noisy batch-wise gradient contribution that meet or exceed a threshold based on the frequency parameter. In yet another example, the noise added to the batch-wise gradient contribution and the noise added to the respective gradients have different scales.

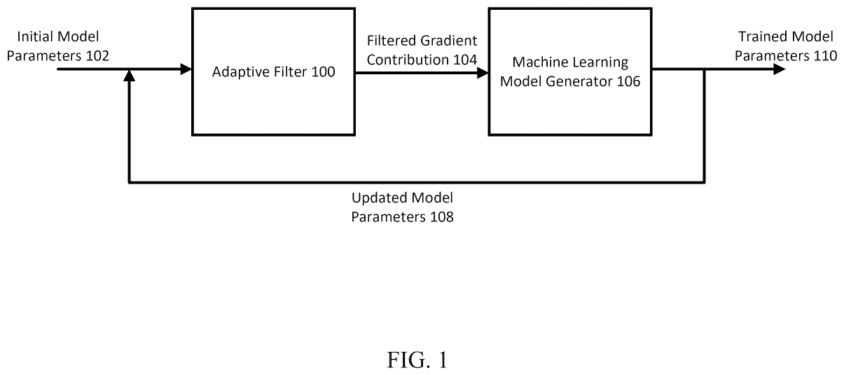

FIG. 1 depicts a block diagram of an example adaptive filter 100. The adaptive filter 100 can receive a batch-wise gradient contribution based on a machine learning model with initial model parameters 102 and filter the batch-wise gradient contribution to generate a filtered gradient contribution 104. The adaptive filter 100 can filter the batch-wise gradient contribution based on a frequency parameter to exclude non-significant gradient entries for focusing on relevant and informative features. A machine learning model generator 106 can receive the filtered gradient contribution 104 and update the initial model parameters 102 based on the filtered gradient contribution 104 to generate a machine learning model with updated model parameters 108. The adaptive filter 100 can receive an updated batch-wise gradient contribution based on the machine learning model with updated model parameters 108. The adaptive filter 100 and machine learning model generator 106 can respectively generate filtered gradient contributions 104 and machine learning models with updated model parameters 108 for a number of training steps. After the number of training steps, the machine learning model generator 106 can generate a trained machine learning model with trained model parameters 110.

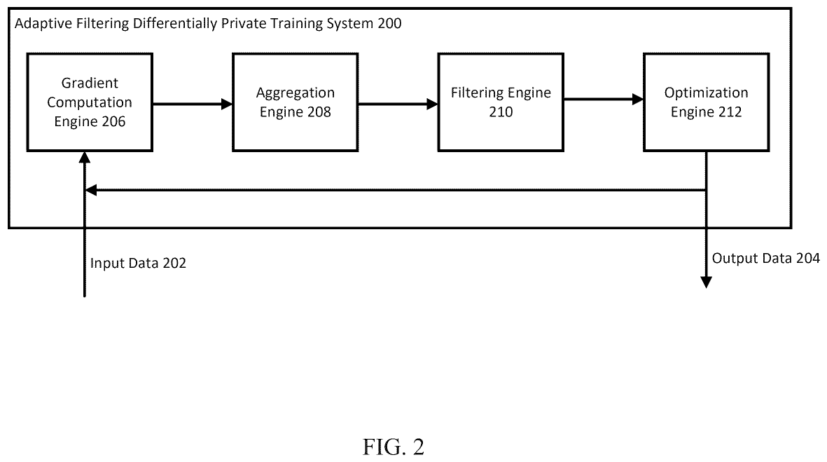

FIG. 2 depicts a block diagram of an adaptive filtering differentially private training system 200 for training machine learning models with differentially private labels. The adaptive filtering training system 200 can be implemented on one or more computing devices in one or more locations.

The adaptive filtering training system 200 can be configured to receive input data 202. For example, the adaptive filtering training system 200 can receive the input data 202 as part of a call to an application programming interface (API) exposing the adaptive filtering training system 200 to one or more computing devices. The input data 202 can also be provided to the adaptive filtering training system 200 through a storage medium, such as remote storage connected to the one or more computing devices over a network. The input data 202 can further be provided as input through a user interface on a client computing device coupled to the adaptive filtering training system 200.

The input data 202 can include training data for training a machine learning model having initial model parameters θ₀. The input data 202 can further include one or more parameters for training the machine learning model, including a learning rate η, a batch size B, a number of training steps T, one or more clipping norms, e.g., C₁, C₂, a frequency threshold parameter c, and one or more noise multipliers, e.g., σ₁, σ₂. Learning rate may refer to a configurable parameter for controlling how fast the machine learning model can adapt to a task. Batch size may refer to a configurable parameter for controlling the number of training samples processed during each training step. Clipping norm may refer to a configurable parameter for controlling how much to mask the gradients when gradient clipping.

The noise multipliers can be associated with privacy parameters ε and δ, representing a scale of differential privacy implemented during training of the machine learning model. Differential privacy may refer to a framework for ensuring the privacy of individuals in datasets, providing a strong guarantee of privacy by allowing data to be analyzed without revealing information about any individual in the dataset. Differential privacy can be satisfied for A when, for any two neighboring datasets D and D′, e.g., datasets such that one can be obtained from the other by adding or removing one example, and any subset S of outputs, the following holds for privacy parameters ε∈R>₀ and δ∈[0,1): Pr Pr [A(D)∈S]≤e^{ε}·Pr Pr [A(D′)∈S]+δ.

Differential privacy stochastic gradient descent (DP-SGD) refers to a methodology for training deep learning models with differential privacy by modifying the mini-batch stochastic optimization process through the use of per-example gradient clipping and Gaussian noise injection. When training a machine learning model f parameterized by θ with a per-example loss function l(·,·) on dataset D, each optimization step t can involve randomly sampling a mini-batch Bₜ. It should be noted the specific loss function depends on the particular task and model. An example loss function can be cross-entropy loss for classification. From Bₜ, a per-example gradient is computed for each (xᵢ, yᵢ)∈Bₜ, where xᵢ is the feature vector and yᵢ is the corresponding label. For example, the per-example gradient is computed by: gₜ(xᵢ, yᵢ)←∇_{θ}_{ₜ}l(f_{θ}_{ₜ}(xᵢ), yᵢ). The per-example gradient is clipped based on a clipping norm C. For instance, the per-example gradient is clipped by:

$${[ {g}_{t} ( {x}_{i} , {y}_{i} ) ]}_{C} := {g}_{t} ( {x}_{i} , {y}_{i} ) / max ( ( 1 , \frac{{‖ {g}_{t} ( {x}_{i} , {y}_{i} ) ‖}_{2}}{C} ) ) .$$

A private gradient ĝₜ is generated by injecting Gaussian noise into the sum of the clipped per-example gradients, such as by:

$${\hat{g}}_{t} ← \frac{1}{‖ {B}_{t} ‖} ( {\sum }_{i} {[ {g}_{t} ( {x}_{i} , {y}_{i} ) ]}_{C} + N ( 0 , {σ}^{2} {C}^{2} I ) ) ,$$

where N(0, σ²C²I) is a Gaussian distribution with mean 0 and covariance of σ²C²I and the noise multiplier σ is computed from (ε, δ), such as by inverse privacy accounting.

Although DP-SGD has been demonstrated to be effective for training ML models with DP, DP-SGD adds noise to all the coordinates of the gradient, which would completely remove any sparsity structure in the original gradients. This densification of sparse gradients may be problematic for large embedding models, where the sparsity is heavily leveraged to improve efficiency.

The input data 202 can be associated with any machine learning task, such as predicting conversions for digital content or other digital content management. The machine learning model can be a sparse model, such as a large embedding model having large embedding layers for processing high-dimensional sparse inputs such as words/tokens in language models and categorical features associated with users or items in recommendation systems.

The training data can correspond to a training set D, including examples of categorical features. The training data can be split into a training set, a validation set, and/or a testing set. An example training/validation/testing split can be an 80/10/10 split, although any other split may be possible. As an example, for large embedding models, an input x with the ith feature can be represented as a one-hot vector eᵢ∈R^{c} that is 1 on the ith coordinate and 0 everywhere else, where c is the number of possible values of an input feature, such as the vocabulary size for text models. Feature values may also be referred to as feature buckets, as string-valued categorical features can be preprocessed via hash-map bucketization. The output of an embedding layer can be computed as a linear map z=W^{T}x, where W∈R^{c×d} can be the parameters of the embedding layer, e.g., the embedding table, and the output dimension d can be the embedding size.

For a one-hot input x=eᵢ, the embedding output can be the ith row of the embedding table: z=W[i,:]. The gradient of the embedding table can be

$$∇ W = x ⊗ \frac{\partial L}{\partial z}$$

where ⊗ can be the outer product and

$$\frac{\partial L}{\partial z} ∈ {R}^{d}$$

can be the partial derivative of the loss with respect to the embedding output. For a one-hot input x=eᵢ, the result of this outer product is a sparse matrix whose ith row equals

$$\frac{\partial L}{\partial z} .$$

For a mini-batch stochastic gradient descent training, the number of non-zero rows in the batch averaged gradient of the embedding table is upper bounded by the batch size, which is typically orders magnitude smaller than c. As such, the gradient sparsity, e.g., the fraction of zero gradient coordinates, for a large embedding model can be high.

Due to this structured sparsity, both forward and backward computations of an embedding layer can be implemented efficiently with gathers and scatters, without expensive matrix multiplication, particularly given that in real-world applications the embedding tables are very large, such as a vocabulary size c ranging from tens of thousands in language models to millions in recommendation models. Moreover, in some large recommendation models, there are hundreds of different categorical features, each with a different embedding table. Therefore, maintaining gradient sparsity allows for significantly reducing computational complexity, as computationally complex matrix multiplication can be replaced with gathers and scatters. Gathers and scatters may refer to a memory addressing technique that enables simultaneous collection, e.g., gathering, or storage, e.g., scattering, of data to multiple arbitrary indices. It should be noted the above description focuses on single-variate features, which only activates one feature value at a time, but multivariate features activating multiple values may also implement the technology generally disclosed herein.

From the input data 202, the adaptive filtering training system 200 can be configured to output one or more results generated as output data 204. The output data 204 can include a trained machine learning model with trained model parameters θ_{T}. As an example, the adaptive filtering training system 200 can be configured to send the output data 204 for display on a client or user display. As another example, the adaptive filtering training system 200 can be configured to provide the output data 204 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The adaptive filtering training system 200 can further be configured to forward the output data 204 to one or more other devices configured for translating the output data into an executable program written in a computer programming language. The adaptive filtering training system 200 can also be configured to send the output data 204 to a storage device for storage and later retrieval.

The adaptive filtering training system 200 can include a gradient computation engine 206, an aggregation engine 208, a filtering engine 210, and an optimization engine 212. The gradient computation engine 206, aggregation engine 208, filtering engine 210, and optimization engine 212 can be implemented as one or more computer programs, specially configured electronic circuitry, or any combination thereof. The gradient computation engine 206, aggregation engine 208, filtering engine 210, and optimization engine 212 can perform training steps to update the model parameters. In each training step, the adaptive filtering training system 200 adaptively preserves the most important gradients through a configurable frequency parameter.

For the initial training step, the gradient computation engine 206 can be configured to generate per-example gradient contributions, including a per-example gradient and a gradient contribution map from the initial model parameters and training dataset for each mini-batch based on the one or more parameters. For subsequent training steps, the gradient computation engine 206 can be configured to generate a per-example gradient and a gradient contribution map from the updated model parameters and training dataset for each mini-batch based on the one or more parameters. The gradient contribution map can be a binary vector indicating which categorical feature buckets have been activated for each example in the mini-batch. For example, the gradient computation engine 206 can generate mini-batches Bₜ of size B from the training dataset D, such as by uniform or random samplings. For each mini-batch, e.g., i=1 to B, the gradient computation engine 206 can compute a per-example gradient gᵢ and a gradient contribution map vᵢ, where vᵢ[j]:=1[gᵢ[j,:]≠0].

The aggregation engine 208 can be configured to generate a noisy batch-wise gradient contribution which ensures differential privacy, including a noisy aggregated gradient and a private contribution map from the per-example gradients and gradient contribution maps by aggregating and adding noise and/or clipping. The aggregation engine 208 can respectively aggregate the per-example gradients and gradient contribution maps to construct an aggregated gradient and an aggregated contribution map. The aggregation engine 208 can further clip the per-example gradients based on one or more clipping norms prior to aggregation for ensuring the contribution of any individual gradient is sufficiently masked. The aggregation engine 208 can add noise, such as Gaussian noise with scale σ₁, respectively to the aggregated gradient and aggregated contribution map to generate a noisy aggregated gradient and a noisy aggregated contribution map, representing the noisy batch-wise gradient contribution. For example, the aggregation engine 208 can compute the noisy aggregated contribution map, which also may be referred to as the private contribution map, as

$${V}_{t} = {\sum }_{i ∈ {B}_{t}} {[ {v}_{i} ]}_{{C}_{1}} + {C}_{1} \cdot N ( 0 , {σ}_{1}^{2} \cdot {I}_{c} ) .$$

The filtering engine 210 can be configured to threshold the noisy batch-wise gradient contribution based on a frequency parameter τ to generate a filtered batch-wise gradient contribution for excluding non-significant gradient entries to which only a few examples in the mini-batch contribute. The frequency parameter τ can be a configurable real-valued number, e.g., 1.0, 2.0, 5.0, etc. The filtering engine 210 can focus training on more relevant and informative features while reducing the impact of noisy or insignificant contributions. For example, for each mini-batch, e.g., i=1 to B, the filtering engine 210 can perform the following: gᵢ[j,:]←0, for all j where Vₜ[j]<τ. It should be noted that higher values of the frequency parameter can decrease the gradient size, resulting in a sparser gradient, but excessively high values of the frequency parameter, e.g., greater than 500 for a batch size of 1024, can lead to a sharp drop in model accuracy. As such, the optimal frequency parameter τ can be determined through empirical evaluation, where the frequency parameter can be configured to provide the optimal performance in terms of trade-off between gradient size and model accuracy depending on the batch size. Thresholding via the filtering engine 210 can reduce gradient size, and thus lower computational cost, while maintaining accuracy by only preserving the gradient entries that score higher than the frequency parameter for updating model parameters.

The filtering engine 210 can be further configured to aggregate and add noise, such as Gaussian noise with scale σ₂, to the remaining gradients in the filtered batch-wise gradient contribution. It should be noted the scale σ₂ of noise added by the filtering engine 210 can be the same scale or a different scale as the scale σ₁ of noise added by the aggregation engine 208. Of particular note, larger ratios of

$$\frac{{σ}_{1}}{{σ}_{2}}$$

can result in high accuracy but also higher gradient density. The filtering engine 210 can further be configured to clip the remaining gradients based on one or more clipping norms. It should also be noted the clipping norm C₂ used by the filtering engine 210 can be the same or different as the clipping norm C₁ used by the aggregation engine 208. For example, the filtering engine 210 can be configured to generate the filtered batch-wise gradient contribution as follows:

$${G}_{t} = {\sum }_{i ∈ {B}_{t}} {[ {g}_{i} ]}_{{C}_{2}} + {C}_{2} \cdot N ( 0 , {σ}_{2}^{2} \cdot diag ( {( {1}_{\{ {V}_{t} [ j ] \geq τ \}} )}_{j ∈ [ c ]} ⊗ {1}_{d} ) ) .$$

The filtering engine 210 allows for adaptive feature selection while maintaining differential privacy guarantees.

Alternatively, or additionally, the filtering engine 210 can be configured to select a top-k most informative, e.g., frequent, buckets of each categorical feature and add noise, such as Gaussian noise, only to the gradients of the selected buckets during training. Top-k can be a configurable hyperparameter referring to a configurable amount of buckets with the highest frequency, where the configurable amount is equal to k. This frequency filtering can significantly reduce the noise added to the gradient by restricting the noise to only the most impactful subset of features. The filtering engine 210 can select the top-k buckets based on prior information on bucket frequency available publicly, such as token frequency in the pretraining set of the machine learning model for language tasks. Alternatively, or additionally, the filtering engine 210 can select the top-k buckets by running differential privacy top-k selection. Differential privacy top-k selection can include counting a frequency of each bucket in the dataset, injecting noise, e.g., Gumbel noise, into the frequency counts, and calculating the top-k buckets based on the noisy frequency count.

For the initial and subsequent training steps, the optimization engine 212 can be configured to generate updated model parameters from the initial or previously updated model parameters based on the filtered batch-wise gradient contribution and learning rate. For the final training step, the optimization engine 212 can be configured generate trained model parameters from updated model parameters based on the filtered batch-wise gradient contribution and learning rate. For example, the optimization engine 212 can compute θₜ₊₁←θₜ−ηGₜ. The optimization engine 212 can send the updated parameters back to the gradient computation engine 206 and can output the trained parameters as output data 204.

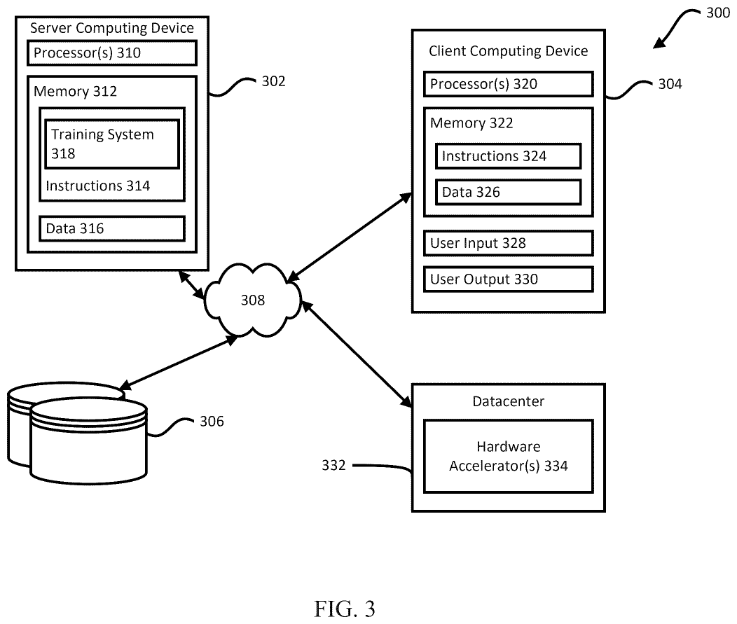

FIG. 3 depicts a block diagram of an example environment 300 for implementing an adaptive filtering training system 318. The adaptive filtering training system 318 can be implemented on one or more devices having one or more processors in one or more locations, such as in server computing device 302. Client computing device 304 and the server computing device 302 can be communicatively coupled to one or more storage devices 306 over a network 308. The storage devices 306 can be a combination of volatile and non-volatile memory and can be at the same or different physical locations than the computing devices 302, 304. For example, the storage devices 306 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 302 can include one or more processors 310 and memory 312. The memory 312 can store information accessible by the processors 310, including instructions 314 that can be executed by the processors 310. The memory 312 can also include data 316 that can be retrieved, manipulated, or stored by the processors 310. The memory 312 can be a type of transitory or non-transitory computer readable medium capable of storing information accessible by the processors 310, such as volatile and non-volatile memory. The processors 310 can include one or more central processing units (CPUs), graphic processing units (GPUs), field-programmable gate arrays (FPGAs), and/or application-specific integrated circuits (ASICs), such as tensor processing units (TPUs).

The instructions 314 can include one or more instructions that, when executed by the processors 310, cause the one or more processors 310 to perform actions defined by the instructions 314. The instructions 314 can be stored in object code format for direct processing by the processors 310, or in other formats including interpretable scripts or collections of independent source code modules that are interpreted on demand or compiled in advance. The instructions 314 can include instructions for implementing an adaptive filtering training system 318, which can correspond to the adaptive filtering training system 200 as depicted in FIG. 2. The adaptive filtering training system 318 can be executed using the processors 310, and/or using other processors remotely located from the server computing device 302.

The data 316 can be retrieved, stored, or modified by the processors 310 in accordance with the instructions 314. The data 316 can be stored in computer registers, in a relational or non-relational database as a table having a plurality of different fields and records, or as JSON, YAML, proto, or XML documents. The data 316 can also be formatted in a computer-readable format such as, but not limited to, binary values, ASCII, or Unicode. Moreover, the data 316 can include information sufficient to identify relevant information, such as numbers, descriptive text, proprietary codes, pointers, references to data stored in other memories, including other network locations, or information that is used by a function to calculate relevant data.

The client computing device 304 can also be configured similarly to the server computing device 302, with one or more processors 320, memory 322, instructions 324, and data 326. The client computing device 304 can also include a user input 328 and a user output 330. The user input 328 can include any appropriate mechanism or technique for receiving input from a user, such as keyboard, mouse, mechanical actuators, soft actuators, touchscreens, microphones, and sensors.

The server computing device 302 can be configured to transmit data to the client computing device 304, and the client computing device 304 can be configured to display at least a portion of the received data on a display implemented as part of the user output 330. The user output 330 can also be used for displaying an interface between the client computing device 304 and the server computing device 302. The user output 330 can alternatively or additionally include one or more speakers, transducers or other audio outputs, a haptic interface or other tactile feedback that provides non-visual and non-audible information to the platform user of the client computing device 304.

Although FIG. 3 illustrates the processors 310, 320 and the memories 312, 322 as being within the respective computing devices 302, 304, components described herein can include multiple processors and memories that can operate in different physical locations and not within the same computing device. For example, some of the instructions 314, 324 and the data 316, 326 can be stored on a removable SD card and others within a read-only computer chip. Some or all of the instructions 314, 324 and data 316, 326 can be stored in a location physically remote from, yet still accessible by, the processors 310, 320. Similarly, the processors 310, 320 can include a collection of processors that can perform concurrent and/or sequential operation. The computing devices 302, 304 can each include one or more internal clocks providing timing information, which can be used for time measurement for operations and programs run by the computing devices 302, 304.

The server computing device 302 can be connected over the network 308 to a data center 332 housing any number of hardware accelerators 334. The data center 332 can be one of multiple data centers or other facilities in which various types of computing devices, such as hardware accelerators, are located. Computing resources housed in the data center 332 can be specified for deploying models, such as for personalized recommendation systems, conversion prediction, or any other digital content management, as described herein.

The server computing device 302 can be configured to receive requests to process data from the client computing device 304 on computing resources in the data center 332. For example, the environment 300 can be part of a computing platform configured to provide a variety of services to users, through various user interfaces and/or application programming interfaces (APIs) exposing the platform services. As an example, the variety of services can include predicting conversions from digital content interaction, e.g., whether a purchase of an item or service was completed or not in response to clicking on an advertisement associated with the item or service. The client computing device 304 can transmit input data as part of a query for a particular task. The adaptive filtering training system 318 can receive the input data, and in response, generate output data including a response to the query for the particular task.

The server computing device 302 can maintain a variety of models in accordance with different constraints available at the data center 332. For example, the server computing device 302 can maintain different families for deploying models on various types of TPUs and/or GPUs housed in the data center 332 or otherwise available for processing.

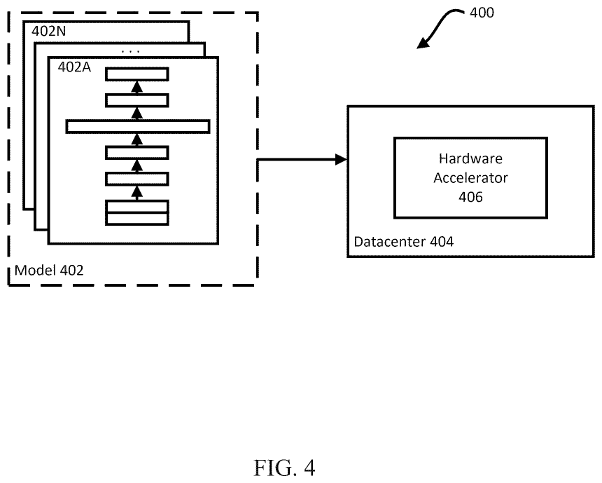

FIG. 4 depicts a block diagram 400 illustrating one or more machine learning model architectures 402, more specifically 402A-N for each architecture, for deployment in a datacenter 404 housing a hardware accelerator 406 on which the deployed machine learning models 402 will execute, such as for the variety of services as described herein. The hardware accelerator 406 can be any type of processor, such as a CPU, GPU, FPGA, or ASIC such as a TPU.

An architecture 402 of a machine learning model can refer to characteristics defining the model, such as characteristics of layers for the model, how the layers process input, or how the layers interact with one another. The architecture 402 of the machine learning model can also define types of operations performed within each layer. One or more machine learning model architectures 402 can be generated that can output results, such as for recommendation systems, conversion prediction, or any other form of digital content management. Example model architectures 402 can correspond to large embedding models.

The machine learning models can be trained according to a variety of different learning techniques. Learning techniques for training the machine learning models can include supervised learning, unsupervised learning, semi-supervised learning, and reinforcement learning techniques. For example, training data can include multiple training examples that can be received as input by the machine learning models. The training examples can be labeled with a desired output for the model when processing the labeled training examples. The training examples can be labeled with noisy labels that guarantee label differential privacy. The noisy labels and the model output can be evaluated through a loss function to determine an error, which can be back propagated through the machine learning model to update weights for the model.

For example, a supervised learning technique can be applied to calculate an error between outputs, with a ground-truth label of a training example processed by the machine learning models. Any of a variety of loss or error functions appropriate for the type of the task the model is being trained for can be utilized, such as cross-entropy loss for classification tasks, or Poisson log loss or squared loss for regression tasks. The gradient of the error with respect to the different weights of the candidate model on candidate hardware can be calculated, for example using a backpropagation algorithm, and the weights for the model can be updated.

Referring back to FIG. 3, the devices 302, 304 and the data center 332 can be capable of direct and indirect communication over the network 308. For example, using a network socket, the client computing device 304 can connect to a service operating in the data center 332 through an Internet protocol. The devices 302, 304 can set up listening sockets that may accept an initiating connection for sending and receiving information. The network 308 can include various configurations and protocols including the Internet, World Wide Web, intranets, virtual private networks, wide area networks, local networks, and private networks using communication protocols proprietary to one or more companies. The network 308 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 308, in addition or alternatively, can also support wired connections between the devices 302, 304 and the data center 332, including over various types of Ethernet connection.

Although a single server computing device 302, client computing device 304, and data center 332 are shown in FIG. 3, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing machine learning models, or any combination thereof.

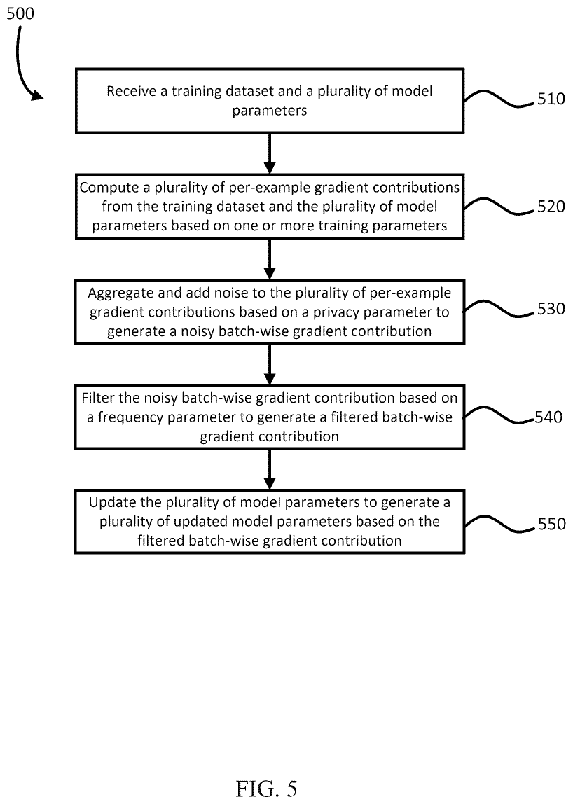

FIG. 5 depicts a flow diagram of an example process 500 for a training step for training one or more sparse machine learning models while guaranteeing differential privacy. The example process can be performed on a system of one or more processors in one or more locations, such as the adaptive filtering training system 200 as depicted in FIG. 2.

As shown in block 510, the adaptive filtering training system 200 receives a training dataset and a plurality of model parameters representing the machine learning model. The training dataset can include a plurality of examples, each example including a plurality of features and a corresponding label for the plurality of features. The plurality of model parameters can be initial model parameters for the first training step and updated model parameters for subsequent training steps. The machine learning model can be a sparse machine learning model, such as a large embedding model having large embedding layers for processing high-dimensional sparse inputs such as words and/or tokens in language models and/or categorical features associated with users or items in recommendation systems.

The adaptive filtering training system 200 can further receive one or more training parameters for training the machine learning model. The one or more training parameters can include learning rate, number of training steps, batch size, one or more noise multipliers associated with a privacy parameter, and/or one or more clipping norms.

As shown in block 520, the adaptive filtering training system 200 computes a plurality of per-example gradient contributions from the training dataset and the plurality of model parameters based on the one or more training parameters. The adaptive filtering training system 200 can generate mini-batches, e.g., subsets, of the training dataset based on the batch size by uniform or random sampling and compute a gradient and gradient contribution map for each example in the mini-batches.

As shown in block 530, the adaptive filtering training system 200 aggregates and adds noise to the plurality of per-example gradient contributions based on a privacy parameter to generate a noisy batch-wise gradient contribution that guarantees differential privacy. The adaptive filtering training system 200 can aggregate and add noise to the gradient contribution maps based on a clipping norm and noise multiplier to generate a private contribution map. The adaptive filtering training system 200 can further clip the per-example gradient contributions based on the clipping norm.

As shown in block 540, the adaptive filtering training system 200 filters the noisy batch-wise gradient contribution based on a frequency parameter to generate a filtered batch-wise gradient contribution. The adaptive filtering training system 200 can remove per-example gradients that are below a threshold associated with the frequency parameter to focus on more relevant and informative features while reducing the impact of noisy or insignificant contributions. The adaptive filtering training system 200 can further aggregate and add noise to the remaining gradients in the filtered batch-wise gradient contribution based on a clipping norm and noise multiplier.

As shown in block 550, the adaptive filtering training system 200 updates the plurality of model parameters to generate a plurality of updated model parameters based on the filtered batch-wise gradient contribution. The adaptive filtering training system 200 can update the plurality of model parameters based further on a learning rate. For the last training iteration, the adaptive filtering training system 200 can update the plurality of updated model parameters to generate a plurality of trained model parameters based on the filtered batch-wise gradient contribution.

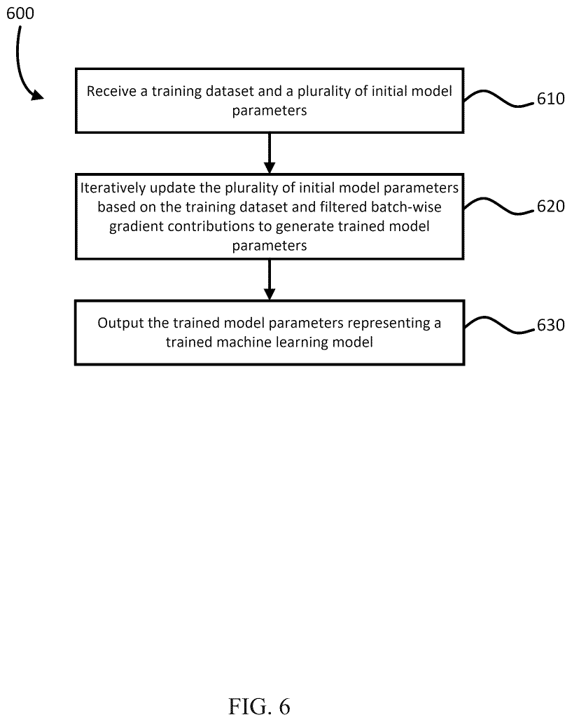

FIG. 6 depicts a flow diagram of an example process 600 for training one or more sparse machine learning models while guaranteeing differential privacy. The example process can be performed on a system of one or more processors in one or more locations, such as the adaptive filtering training system 200 as depicted in FIG. 2.

As shown in block 610, the adaptive filtering training system 200 can receive a training dataset and a plurality of initial model parameters associated with a sparse machine learning model to be trained. The adaptive filtering training system 200 can further receive one or more training parameters, such as learning rate, number of training steps, batch size, noise multiplier associated with a privacy parameter, and/or clipping norm, indicating how the sparse machine learning model will be trained. Block 610 can generally correspond to block 510 as depicted in FIG. 5.

As shown in block 620, the adaptive filtering training system 200 can iteratively update the plurality of initial model parameters based on the training dataset and filtered batch-wise gradient contributions to generate a plurality of trained model parameters. The adaptive filtering training system 200 can perform a number of training steps as depicted in FIG. 5 based on the received number of training steps parameter to generate updated model parameters for each training step. The final training step can generate the trained model parameters.

As shown in block 630, the adaptive filtering training system 200 can output the trained model parameters to represent a trained sparse machine learning model satisfying differential privacy.

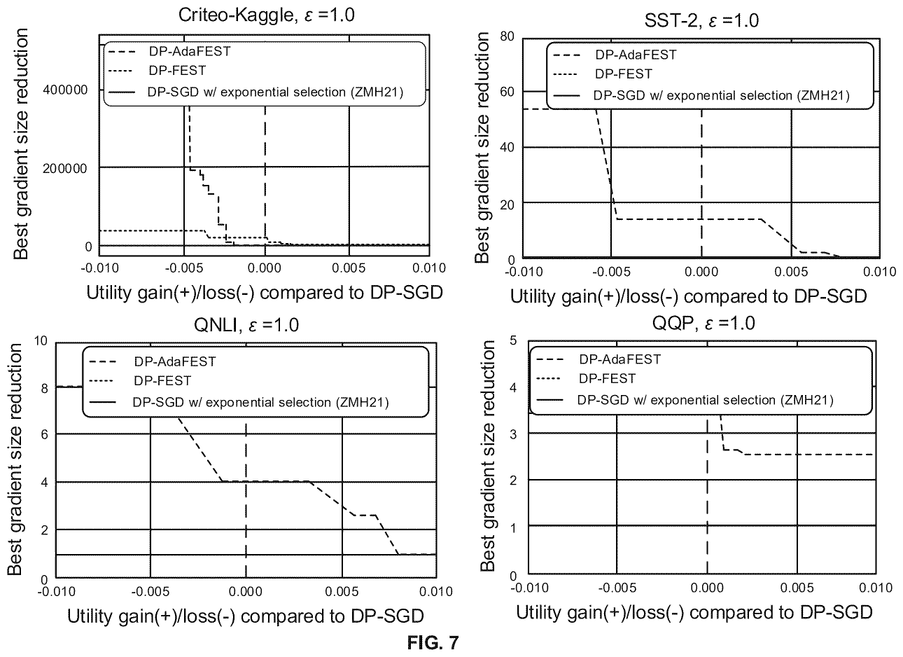

As illustrated in FIGS. 7-11, the adaptive filtering training system as disclosed herein can achieve or improve upon alternative approaches for training sparse machine learning models while guaranteeing differential privacy. Examples of the adaptive filtering training system, both examples DP-AdaFEST associated with the frequency parameter τ and DP-FEST associated with the top-k parameter, were compared to a baseline stochastic gradient descent on recommendation and language understanding tasks.

The adaptive filtering training system was evaluated on a Criteo predicted click-through rate (pCTR) dataset, which includes over four billion ad impressions over 24 days. Each impression is represented by 13 numerical features and 26 categorical features. The objective is to predict how likely a user clicks on an ad based on these features. The pCTR model used for evaluation is a neural network that uses embedding layers for categorical features and log transformations for numerical features, followed by several fully connected layers. Binary cross-entropy loss is used as the training objective and area under curve (AUC) is reported as the evaluation metric.

Two Criteo variants are utilized for evaluation: Criteo-Kaggle and Criteo-time-series. Criteo-Kaggle refers to a subset of examples, about 45 million in total, used in studies of click-through rate modeling. Note that timestamps are absent in Criteo-Kaggle. Criteo-time-series, or Criteo-1 TB, is the entire Criteo dataset of over 4 billion examples and has auxiliary information indicating which day the data was collected. To simulate a real-world online training scenario, the model is trained on the first 18 days of data and evaluated on subsequent days, e.g., days 19-24.

For language understanding tasks, language models from the BERT family are employed, specifically the RoBERTa model. This model has a vocabulary size of 50, 265 subword tokens and has been pre-trained on public web data. The RoBERTa model is further fine-tuned for downstream classification tasks from the GLUE benchmark, including SST-2, QNLI, and QQP. Low-Rank Adaptation (LoRA) is adopted to introduce trainable rank decomposition matrices into each transformer block of the language model. This approach significantly reduces the number of parameters required for downstream tasks while also improving the privacy-utility trade-off. The word embedding layers are also trained in DP fine-tuning to enable bucket selection. This leads to significant accuracy improvements in the model.

The performance of DP-SGD and three sparsity-preserving variants, DP-SGD with exponential selection, DP-FEST, and DP-AdaFEST, are evaluated on both the click-through rate prediction and language understanding tasks. A fixed batch size of 2,048 is used for the former and 1,024 for the latter. For all tasks, the privacy parameter δ is set to 1/N, where N is the number of training examples for the respective task.

First, datasets with no timestamp are considered: Criteo-Kaggle, SST-2, QNLI, and QQP. The decision to prioritize gradient sparsity, which impacts computational efficiency, or utility in DP training depends on the task and available computational resources. However, it can be challenging for DP-SGD to cater to different needs of gradient sparsity or utility since it lacks mechanisms for trading off between these objectives. In contrast, DP-SGD with exponential selection, DP-AdaFEST and DP-FEST can all offer diverse options for balancing utility and efficiency via sparsity-controlling parameters, while DP-AdaFEST and DP-FEST offer much better privacy-utility loss. While both DP-FEST and DP-AdaFEST offer ways to balance efficiency and utility in DP training, DP-AdaFEST stands out as the more versatile and customizable methodology. With three adjustable hyper-parameters, DP-AdaFEST offers more diverse results compared to DP-FEST's single parameter, k, which controls the number of preserved top buckets.

The effectiveness of DP-AdaFEST is evident in the graphs in FIG. 7, where it achieves significantly higher gradient size reduction than DP-FEST while maintaining the same level of utility. Specifically, on the Criteo-Kaggle dataset, DP-AdaFEST reduces the gradient computation cost of DP-SGD by more than 5×10⁵ times while maintaining a comparable AUC, e.g., AUC loss less than 0.005. This reduction translates into a more efficient and cost-effective training process. The adoption of sparsity-preserving DP-SGD effectively obviates the dense gradient computation. Furthermore, in line with bias-variance trade-off DP-AdaFEST also can exhibit superior utility compared to DP-SGD when the reduction in gradient size is minimal. Conversely, when incorporating sparsity, DP-SGD with the exponential mechanism faces challenges in maintaining utility. In all configurations, it fails to achieve a tolerable level of utility loss.

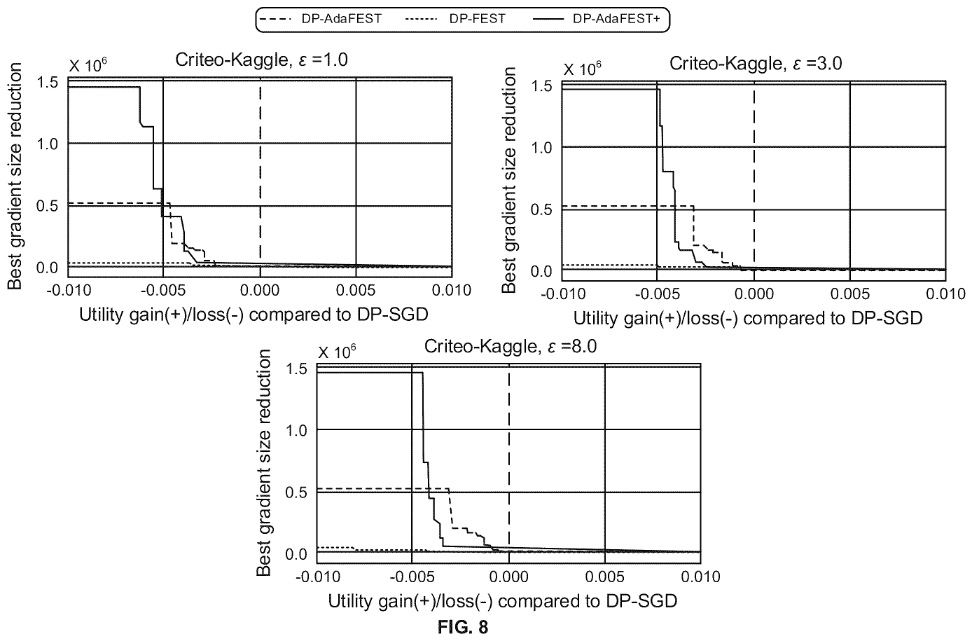

Integrating DP-AdaFEST with DP-FEST can further enhance performance, which involves pre-selecting a subset of buckets using DP-FEST and subsequently training on this subset using DP-AdaFEST. The graphs in FIG. 8 show that the combined methodology, referred to as DP-AdaFEST+, outperforms either alone in utility/efficiency trade-off, with the best gradient size reduction being further improved to >10⁶×. This can be attributed to the complementary strengths of the two approaches: DP-AdaFEST offers a more flexible approach to feature selection at the batch level, while DP-FEST provides a simple yet effective means for feature selection according to global frequency information. Besides, the combined methodology expands the range of choices for balancing gradient sparsity and utility through the combination of hyper-parameters from both DP-FEST and DP-AdaFEST.

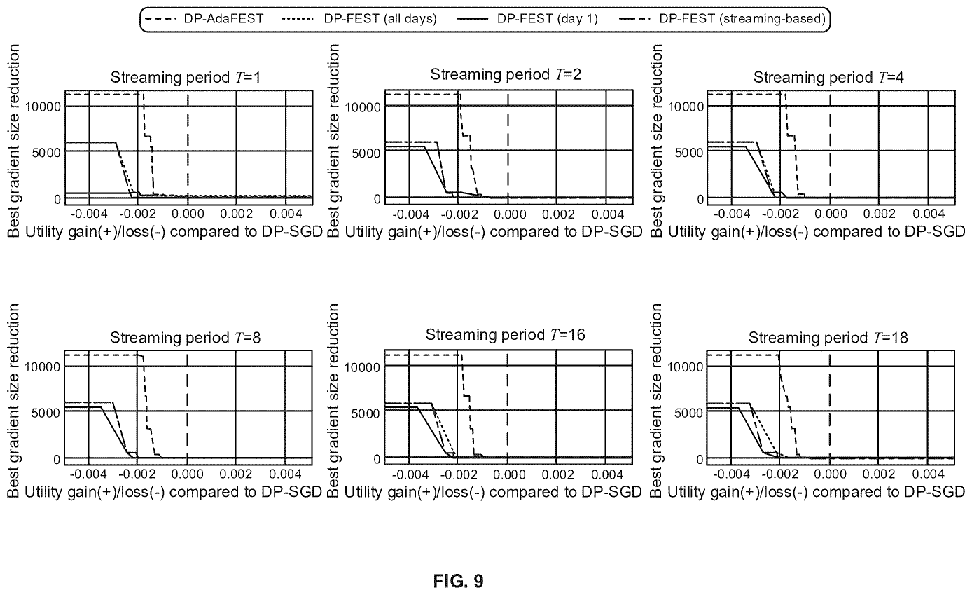

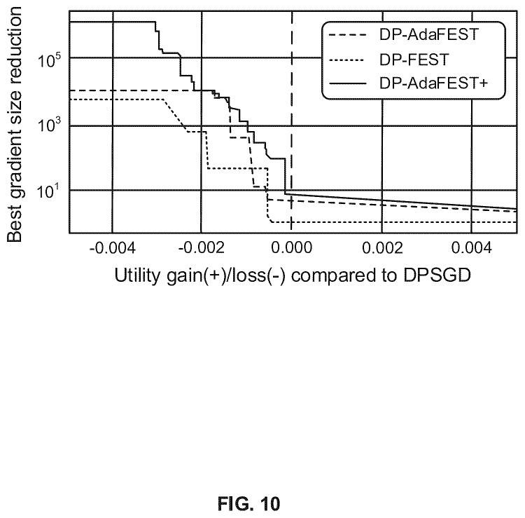

Time-series data are notoriously challenging due to non-stationarity. The performance of DP-FEST and DP-AdaFEST are evaluated in adapting to distribution shifts, a characteristic of time-series data. The evaluations are performed using the Criteo-time-series dataset, which includes real-world user-click data collected over 24 days, 18 days for training and the rest for evaluation. To simulate the online data streaming scenario, a streaming period is introduced, a time interval during which the model is updated as new data is received. The graphs in FIG. 9 present the utility and efficiency trade-off of DP-AdaFEST and DP-FEST for time-series data. To explore the efficacy of DP-FEST, different sources of vocabulary frequency are evaluated, including the information from the first day, all days, and streaming-based, e.g., running sum updated per streaming period. The evaluation indicates that using streaming-based frequency information for DP-FEST is almost as effective as using all-day frequency information and significantly better than using information only from the first day. Additionally, DP-AdaFEST consistently outperforms DP-FEST, achieving more than twice the gradient reduction at the same level of utility. The advantages of combining DP-AdaFEST and DP-FEST are evaluated to enhance the utility/efficiency trade-off on the Criteo-time-series dataset. A streaming period of 1 and streaming-based frequency information for DP-FEST are used. The graphs in FIG. 10 demonstrate a consistent superiority of the combined approach over individual methods.

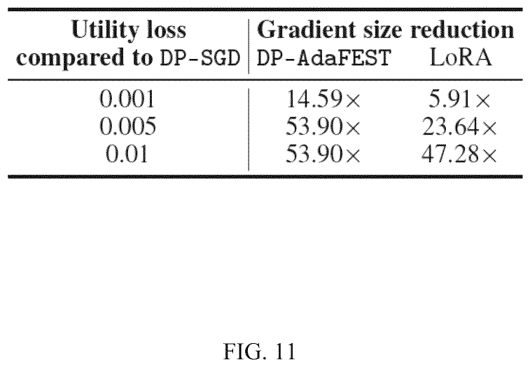

The applicability of DP-AdaFEST to language models is also evaluated by comparing it with LoRA and reporting its performance with multilingual models. DP-AdaFEST is shown to be a better choice than LoRA for embedding layers. The table in FIG. 11 compares the best embedding gradient size reductions achieved by DP-AdaFEST and LoRA against DP-SGD for SST-2 with ε=1.0 on the RoBERTa model. LoRA's rank r is varied from {4, 8, 16, 32, 64, 128}. DP-AdaFEST consistently outperforms LoRA in gradient size reduction at similar utility levels.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” or “data processing system” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for training a sparse machine learning model comprising:
receiving, by one or more processors, a training dataset and a plurality of model parameters;
computing, by the one or more processors, a plurality of per-example gradient contributions from the training dataset and the plurality of model parameters based on one or more training parameters;
aggregating and adding, by the one or more processors, noise to the plurality of per-example gradient contributions based on a privacy parameter to generate a noisy batch-wise gradient contribution;
filtering, by the one or more processors, the noisy batch-wise gradient contribution based on a frequency parameter to generate a filtered batch-wise gradient contribution; and
updating, by the one or more processors, the plurality of model parameters to generate a plurality of updated model parameters based on the filtered batch-wise gradient contribution.

2. The method of claim 1, wherein the one or more training parameters comprise at least one of learning rate, number of training steps, batch size, noise multiplier, or clipping norm.

3. The method of claim 1, further comprising clipping, by the one or more processors, the plurality of per-example gradient contributions.

4. The method of claim 1, further comprising iteratively performing the computing, aggregating, adding, denoising, and updating for a number of training steps.

5. The method of claim 4, further comprising outputting, by the one or more processors, a trained machine learning model with trained model parameters after performing the number of training steps.

6. The method of claim 1, wherein each of the plurality of per-example gradient contributions comprises a per-example gradient and a gradient contribution map.

7. The method of claim 1, wherein the noisy batch-wise gradient contribution comprises a private contribution map.

8. The method of claim 1, wherein filtering the noisy batch-wise gradient contribution further comprises removing per-example gradients that are below a threshold associated with the frequency parameter.

9. The method of claim 1, further comprising aggregating and adding, by the one or more processors, noise to the filtered batch-wise gradient contribution based on the first privacy parameter or a second privacy parameter.

10. The method of claim 1, wherein the sparse machine learning model comprises an embedding model.

11. A system comprising:
one or more processors; and
one or more storage devices coupled to the one or more processors and storing instructions that, when executed by the one or more processors, cause the one or more processors to perform operations for training a sparse machine learning model, the operations comprising:
receiving a training dataset and a plurality of model parameters;
computing a plurality of per-example gradient contributions from the training dataset and the plurality of model parameters based on one or more training parameters;
aggregating and adding noise to the plurality of per-example gradient contributions based on a privacy parameter to generate a noisy batch-wise gradient contribution;
filtering the noisy batch-wise gradient contribution based on a frequency parameter to generate a filtered batch-wise gradient contribution; and
updating the plurality of model parameters to generate a plurality of updated model parameters based on the filtered batch-wise gradient contribution.

12. The system of claim 11, wherein the one or more training parameters comprise at least one of learning rate, number of training steps, batch size, noise multiplier, or clipping norm.

13. The system of claim 11, wherein the operations further comprise clipping the plurality of per-example gradient contributions.

14. The system of claim 11, wherein the operations further comprise iteratively performing the computing, aggregating, adding, denoising, and updating for a number of training steps.

15. The system of claim 14, wherein the operations further comprise outputting a trained machine learning model with trained model parameters after performing the number of training steps.

16. The system of claim 11, wherein each of the plurality of per-example gradient contributions comprises a per-example gradient and a gradient contribution map.

17. The system of claim 11, wherein the noisy batch-wise gradient contribution comprises a private contribution map.

18. The system of claim 11, wherein filtering the noisy batch-wise gradient contribution further comprises removing per-example gradients that are below a threshold associated with the frequency parameter.

19. The system of claim 11, wherein the operations further comprise aggregating and adding noise to the filtered batch-wise gradient contribution based on the first privacy parameter or a second privacy parameter.

20. A non-transitory computer readable medium for storing instructions that, when executed by one or more processors, cause the one or more processors to perform operations for training a sparse machine learning model, the operations comprising:
receiving a training dataset and a plurality of model parameters;
computing a plurality of per-example gradient contributions from the training dataset and the plurality of model parameters based on one or more training parameters;
aggregating and adding noise to the plurality of per-example gradient contributions based on a privacy parameter to generate a noisy batch-wise gradient contribution;
filtering the noisy batch-wise gradient contribution based on a frequency parameter to generate a filtered batch-wise gradient contribution; and
updating the plurality of model parameters to generate a plurality of updated model parameters based on the filtered batch-wise gradient contribution.
